(19) United States
(12) Patent Application Publication
(10) Pub. No.: US 2026/0322697 A1
(43) Pub. Date: Oct. 15, 2026

(54) SYSTEMS AND METHODS FOR NATURAL LANGUAGE-BASED SERVICE DISCOVERY

(71) Applicant: Cisco Technology, Inc., San Jose, CA (US)

(72) Inventors: Alessandro Duminuco, Milano (IT); Hendrikus G. P. Bosch, Amstelveen (NL); Jeffrey M. Napper, Delft (NL)

(21) Appl. No.: 19/242,724

(22) Filed: Jun. 18, 2025

Related U.S. Application Data
(60) Provisional application No. 63/786,696, filed on Apr. 10, 2025.

(51) Int. Cl. H04L 41/12; G06F 40/30; H04L 41/16

(52) U.S. Cl. CPC H04L 41/12; G06F 40/30; H04L 41/16

(57) ABSTRACT

In an embodiment, a method includes receiving a request including a natural-language description of a task, accessing a routing table specifying server capability summaries associated with servers, wherein each server capability summary is in natural language, determining semantic distances between the natural-language description of the task and the respective server capability summaries, identifying a first server among the servers upon determining the semantic distance between the natural-language description of the task and the server capability summary of the first server is the shortest, and transmitting the request including the natural-language description of the task to the first server.

### PRIORITY

This application claims the benefit, under 35 U.S.C. § 119(e), of U.S. Provisional Patent Application No. 63/786,696, filed Apr. 10, 2025, which is incorporated herein by reference.

### TECHNICAL FIELD

This disclosure generally relates to network routing, and in particular relates to systems and methods for natural language-based service discovery.

### BACKGROUND

In today’s Internet, many servers offer Application Programming Interfaces (APIs) to perform specific functions, implement tasks, or solve problems. Typically, these servers are known by a name, e.g., a uniform resource locator (URL). A client device requesting to use a service provided by a server needs to be programmed explicitly for that specific API of the server, which can be cumbersome.

### BRIEF DESCRIPTION OF THE DRAWINGS

FIG. 1 illustrates an example system for natural language-based service discovery, in accordance with certain embodiments.

FIG. 2 illustrates an operational flow for natural language-based service discovery, in accordance with certain embodiments.

FIGS. 3A-3B illustrate a method for natural language-based service discovery, in accordance with certain embodiments.

FIG. 4 illustrates a computer system, in accordance with certain embodiments.

### DESCRIPTION OF EXAMPLE EMBODIMENTS

### OVERVIEW

According to an embodiment, a system may include one or more processors and one or more computer-readable non-transitory storage media including instructions that, when executed by the one or more processors, cause one or more components of the system to perform operations. The operations may include receiving, at a first network device and from a client device, a request including a natural-language description of a task. The operations may further include accessing, by the first network device, a first routing table stored in the first network device. The first routing table may specify a plurality of server capability summaries associated with a plurality of servers, respectively. Each of the plurality of server capability summaries may be in natural language. The operations may further include determining, by the first network device, a plurality of semantic distances between the natural-language description of the task and the plurality of server capability summaries, respectively. The operations may further include identifying, by the first network device, a first server among the plurality of servers upon determining that the semantic distance between the natural-language description of the task and the server capability summary of the first server is the shortest among the plurality of semantic distances. The operations may further include transmitting, by the first network device, the request including the natural-language description of the task to the first server.

In certain embodiments, the operations may further include receiving, at the first network device and from the first server, an execution result of the task. The operations may further include transmitting, by the first network device, the execution result to the client device.

In certain embodiments, the operations may further include receiving, at the first network device and from the plurality of servers, a plurality of announcements. Each of the plurality of announcements may include a natural-language description of one or more server capabilities of the corresponding server. The operations may further include executing, by the first network device, a generative artificial-intelligence (AI) model on the natural-language description of the one or more server capabilities associated with each server to generate a respective server capability summary in natural language. The operations may further include building, by the first network device, the first routing table based on the server capability summary in natural language associated with each of the plurality of servers. The operations may further include storing the first routing table in the first network device.

In certain embodiments, the operations may further include receiving, at the first network device and from one or more second network devices, one or more announcements, respectively. Each of the one or more announcements may include an aggregation of one or more server capabilities associated with one or more servers of the plurality of servers. The one or more servers may be reachable by the corresponding second network device. The aggregation in each of the one or more announcements may be in natural language. The operations may further include building, by the first network device, the first routing table based on the one or more announcements received from the one or more second network devices.

In certain embodiments, transmitting the request including the natural-language description of the task to the first server may include determining, by the first network device based on the first routing table, that the first server is reachable via a second network device and transmitting the request including the natural-language description of the task to the second network device. The second network device may be configured to route the request to the first server.

In certain embodiments, the first routing table may further specify a plurality of application programming interfaces (APIs) associated with the plurality of servers, respectively. The operations may further include identifying a first API associated with the first server. Transmitting the request including the natural-language description of the task to the first server may be via the first API.

According to another embodiment, a method may include receiving, at a first network device and from a client device, a request including a natural-language description of a task. The method may further include accessing, by the first network device, a first routing table stored in the first network device. The first routing table may specify a plurality of server capability summaries associated with a plurality of servers, respectively. Each of the plurality of server capability summaries may be in natural language. The method may further include determining, by the first network device, a plurality of semantic distances between the natural-language description of the task and the plurality of server capability summaries, respectively. The method may further include identifying, by the first network device, a first server among the plurality of servers upon determining that the semantic distance between the natural-language description of the task and the server capability summary of the first server is the shortest among the plurality of semantic distances. The method may further include transmitting, by the first network device, the request including the natural-language description of the task to the first server.

According to yet another embodiment, one or more computer-readable non-transitory storage media may embody instructions that, when executed by a processor, cause the performance of operations. The operations may include receiving, at a first network device and from a client device, a request including a natural-language description of a task. The operations may further include accessing, by the first network device, a first routing table stored in the first network device. The first routing table may specify a plurality of server capability summaries associated with a plurality of servers, respectively. Each of the plurality of server capability summaries may be in natural language. The operations may further include determining, by the first network device, a plurality of semantic distances between the natural-language description of the task and the plurality of server capability summaries, respectively. The operations may further include identifying, by the first network device, a first server among the plurality of servers upon determining that the semantic distance between the natural-language description of the task and the server capability summary of the first server is the shortest among the plurality of semantic distances. The operations may further include transmitting, by the first network device, the request including the natural-language description of the task to the first server.

Technical advantages of certain embodiments of this disclosure may include one or more of the following. Certain systems and methods described herein enable services via a natural-language interface instead of a formally specified API such that a client device requesting to use a service does not need to be programmed explicitly for that specific server since the client device can express its request in natural language. Certain embodiments of this disclosure enable servers to announce their capabilities in natural language such that potential client devices can discover a match for the task they want to execute by semantically matching the task description with the capabilities announced by the servers.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

When a client device wants to consume a specific service, the client device locates the server providing such service in the network, e.g., by performing a name resolution. Then the client device establishes a network connection to consume such service over a specified interface (e.g., a REST (Representational State Transfer) API). The client device then formally expresses a request. The server operates on that request, producing a result that satisfies the request.

Certain client devices needing to solve a problem or perform a specific function may not know the name of a server that can assist, but they need to look for the server. Typically, searching for a server may be completed through a manual search in a “search engine” that would provide a list of services that may fit the request expressed in the search prompt. Most search engines are built by crawling the web and collecting available metadata for reachable resources to index these resources in a database used to perform the search upon user prompts.

The advent of generative artificial intelligence (AI) offers new ways of consuming and discovering services. The interface of such services does not need to be a formally specified API (e.g., REST) but can be a natural-language interface. With a natural-language interface, a client device requesting to use a service does not need to be programmed explicitly for that specific server but could express its request in natural language.

Servers can announce their capabilities in natural language, and potential client devices can find a match for the problem they want to solve by semantically matching the problem description with the capability description announced by the servers.

Given the above, a client device can express the task it needs to execute as a natural-language query, including any relevant constraint, which is then used to search in the network for a server capable of satisfying such request. Certain embodiments disclosed herein implement the natural-language inference of Software as a Service (SaaS)-based services for the above mechanisms in an entirely distributed fashion.

For illustration purposes, the following summarizes how routing works in today’s Internet. As per RFC 791, the Internet is based on the Internet protocol (IP), and each node in the network is associated with a unique address known as an IP address. In accordance with the protocol, each node signals its existence to a nearby router by announcing its IP address. Each router aggregates known reachable IP addresses in a single announcement to nearby routers. Such aggregation may be performed by announcing the shortest possible prefixes, including the IP addresses to be announced. These announcements are propagated and aggregated from router to router via a routing protocol through the Internet, allowing every router to build its routing table. A router’s routing table identifies which interface is possible or most convenient to reach for any given reachable IP address. To establish a connection with another node, the node must know its IP address. The node starts sending packets destined to such an IP address. These packets are forwarded by routers based on the routing table previously built until they can be delivered to the intended destination.

Based on a similar routing protocol to the IP protocol described above, the embodiments disclosed herein implement natural-language inference of services (e.g., SaaS-based services) in a distributed fashion. However, the routing protocol disclosed herein is based on natural-language requests being routed to reach one or more servers capable of satisfying such requests.

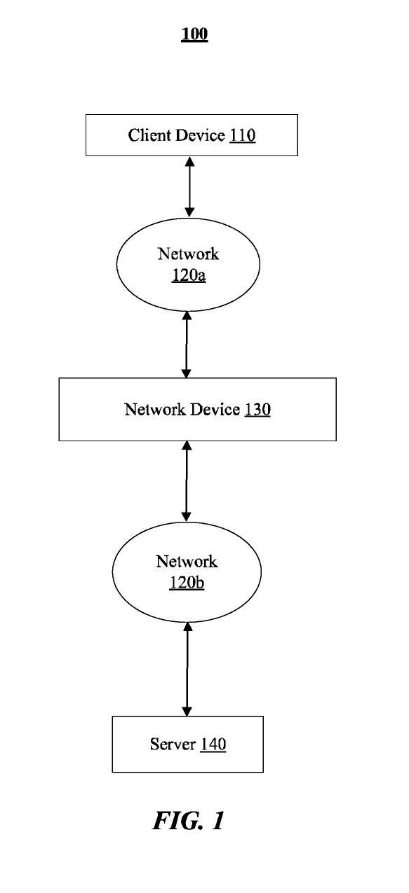

FIG. 1 illustrates an example system 100 for natural language-based service discovery, in accordance with certain embodiments. System 100 includes a client device 110, one or more networks 120 (e.g., network 120aand network 120b), a network device 130, and a server 140. Although FIG. 1 illustrates a particular number of client devices 110, networks 120, network devices 130, and servers 140, this disclosure contemplates any suitable number of client devices 110, networks 120, network devices 130, and servers 140. For example, system 100 may include more than one client device 110, network device 130, or server 140.

To begin with, each server 140 may signal its existence by announcing a natural-language description of its capabilities to a nearby network device 130 via network 120b. For example, the network device 130 can be a router. As another example, the server 140 can signal its capabilities to a local domain name system (DNS) server (network device 130).

In certain embodiments, service announcements by servers 140 are realized by integrating service announcements into Multiprotocol Border Gateway Protocol (MP-BGP). While traditionally BGP was used to signal address information across a network, the servers 140 in the embodiments disclosed herein may announce service capabilities in a new address family. Then, when a BGP listener receives a notification of the availability of services, that BGP listener can incorporate what has been announced into its reachable service topology.

In certain embodiments, service announcements by servers 140 can be realized via certain protocols (e.g., the Bonjour protocol and DNS-based service discovery). Service availability of a server 140 may be signaled by way of multicast DNS techniques. Service announcements using this approach may percolate into MP-BGP.

In certain embodiments, service announcements by servers 140 can be integrated in DNS (e.g., in accordance with RFC9499 and many others such as DNS-based service discovery). As a result, a balance can be found between naming of services and describing the services.

The network device 130 may aggregate all known reachable capabilities of the announcing servers 140 and generate a routing table based on the aggregation. Such aggregation may be performed as a summarization of all the capabilities reachable by this network device 130. In certain embodiments, the aggregation is performed by a generative AI model such as a large language model (LLM). The generative AI model may be operating on the network device 130. In certain embodiments, the network device 130 sends API calls to servers 140 provisioning the service of a generative AI model. The servers 140 may execute the generative AI model based on the capabilities in the announcements and then return the aggregation to the network device 130.

Each network device 130 (e.g., router) may transmit a single announcement including the aggregated capabilities to nearby network devices 130 (e.g., routers or DNS servers). These announcements may be propagated and further aggregated from network device 130 to network device 130 through the Internet such that every network device 130 can build its routing table.

In certain embodiments, the network device 130 may reconcile multiple announcements via a natural-language integration. For example, if one router says “I can route to networks 10.2/16 with a scanner on 10.2.2.4 and 10.3.1/8” and the other router says “I can get to AS 450 and provides routes to 1.2.3/24 and it has a printer on 1.2.3.4”, then the combined routed information can be “Routed networks 10.2/16, 10.3.1/8 and 1.2.3/24 are reachable; 1.2.3/23 is AS 450; a scanner is reachable on 10.2.2.4; a printer is reachable on 1.2.3.4.” In other words, the service information can be combined by way of natural language.

In certain embodiments, the routing table specifies on which API a corresponding server 140 can be reached for any given capabilities described in natural language. For the DNS case, the capability descriptions may flood the DNS space, which means many service-related DNS records may be created. Name-based policies can be used to limit distribution if needed.

When a client device 110 executes a task, the client device 110 is not required to know information about potential servers 140 that can fulfill the task. The client device 110 starts by sending a request to a network device 130 via network 120a. The request may describe in natural language what task needs to be accomplished including all the necessary details. For the DNS case, the client device 110 may resolve the request through the local DNS server.

Upon receiving the request from the client device 110, the network device 130 may execute the request as a natural-language query. The network device 130 may use the natural-language query to search its capability-based routing table to identify in the network a server 140 capable of satisfying such a request. The network device 130 may further forward such a request to the identified server 140. In particular embodiments, a routing protocol based on natural-language requests may be used to route to reach one or more servers 140 capable of satisfying such a request.

In particular embodiments, the request is forwarded by multiple network devices 130 (e.g., routers or DNS servers) based on their respective routing tables previously built until the request is delivered to the intended destination server 140. At each forwarding step, instead of performing a long prefix match on an IP address, the network device 130 may perform a semantic search to find which API is the one that directs the request to a server 140 capable of fulfilling the request.

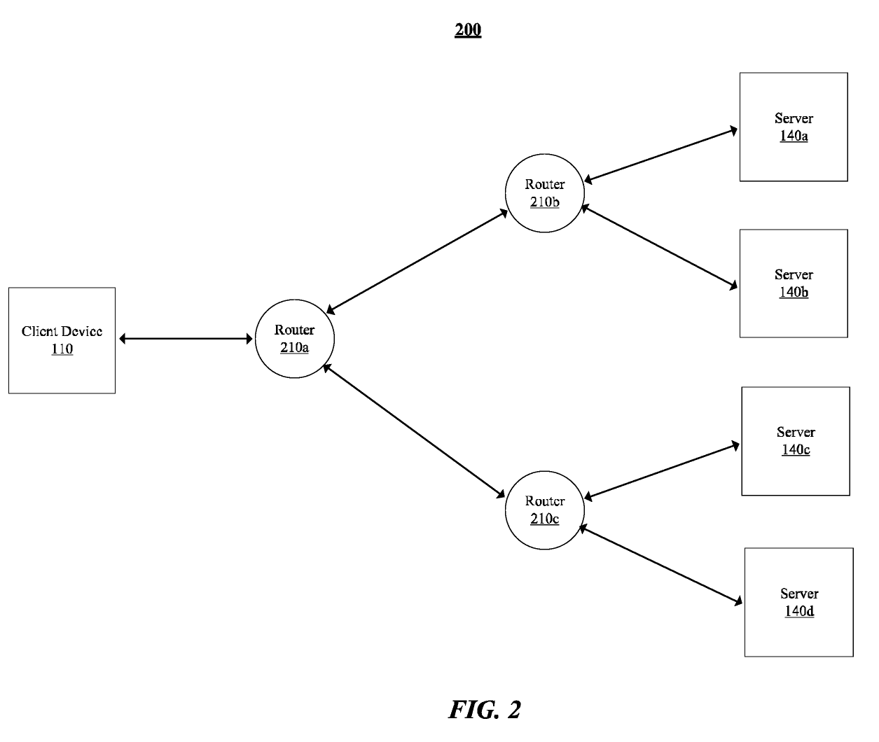

FIG. 2 illustrates an operational flow 200 for natural language-based service discovery, in accordance with certain embodiments. As an example, FIG. 2 shows four servers 140 (server 140a, server 140b, server 140c, and server 140d), one client device 110, and three routers 210 (router 210a, router 210b, and router 210c). Although FIG. 2 illustrates a particular number of client devices 110, routers 210, and servers 140, this disclosure contemplates any suitable number of client devices 110, routers 210, or servers 140. For example, there can be more than one client device 110, more than three routers 210, or more than four servers 140.

Sever 140a may be associated with a pizza restaurant, offering food service. Server 140bmay be associated with a French restaurant, offering food service. Server 140cmay be associated with a first cloud service provider, offering a fist cloud service. Server 140d may be associated with a second cloud service provider, offering a second cloud service.

Each server 140 may announce its capabilities. For example, server 140amay announce, “I can make wonderful pizzas using original Italian ingredients.” Server 140bmay announce, “I prepare the best French cuisine. My specialties are omelets and pate de foie gras.” Server 140cmay announce, “I can run containers and virtual machines. I can also host your database.” Server 140dmay announce, “I offer the best infrastructure to run your virtual workloads.”

At each router 210, the announcements may be aggregated semantically at a corresponding level. For example, router 210bmay receive announcements from server 140aand server 140b and may aggregate the announcements as follows: “I can prepare traditional food from a good number of countries in Europe.” Router 210bmay send the aggregation as a single announcement to router 210a. As another example, router 210cmay receive announcements from servers 140c and 140d and may aggregate the announcements as follows: “I offer Infrastructure as a Service (IaaS) and Platform as a Service (PaaS).” Router 210cmay send the aggregation as a single announcement to router 210a. Router 210a may aggregate the announcements from router 210band router 210c as “I can prepare food and be a cloud provider.”

When the client device 110 issues a request such as “I want a Quattro Stagioni for Dinner”, each router 210 receiving the request may forward the request to the API connected to the router 210 that announces capabilities that are semantically the closest to the request. The request can be routed to server 140a, which is associated with the pizza restaurant, by performing semantic closeness at each level. In this case, “semantically” means finding a close match in a latent space for the natural-language request. To ensure no nonsensical results are provided, a “closeness” to the request is determined based on determining semantic distances between the natural-language request and the capability summaries at the routers 210. Semantic closeness may be a pre-selected probability measure.

In certain embodiments, summarization of server capabilities may be lossy, meaning that the routing tables may be approximate. As such, a request may include enough constraints to allow a router 210 to select only the relevant paths. Similarly, the announcements from servers 140 may carry enough details to allow for the constraints to be checked. For example, a user associated with the client device 110 in FIG. 1 may want to order a pizza only from local pizzerias that are open for dinner, which can be used as constraints by the routers 210 to identify an appropriate server 140 effectively.

Although disclosure describes particular embodiments implemented in a routed network, the disclosed embodiments can be applied to any suitable problems, such as search engines or semantic databases, where one wants to search for the most suitable item that is semantically satisfying a request.

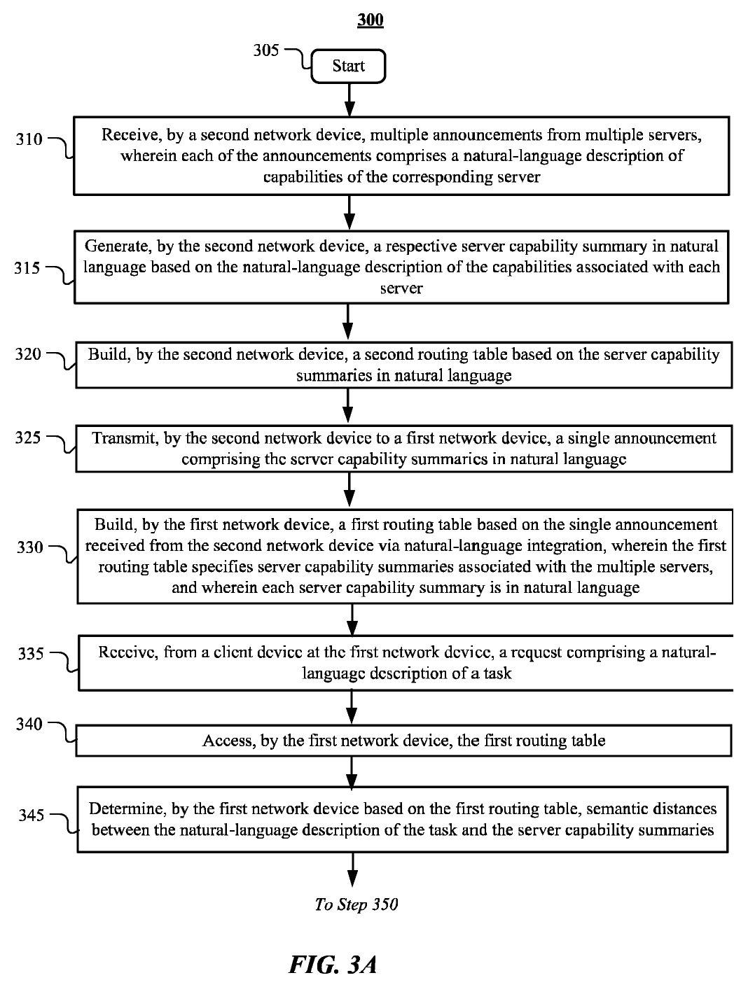

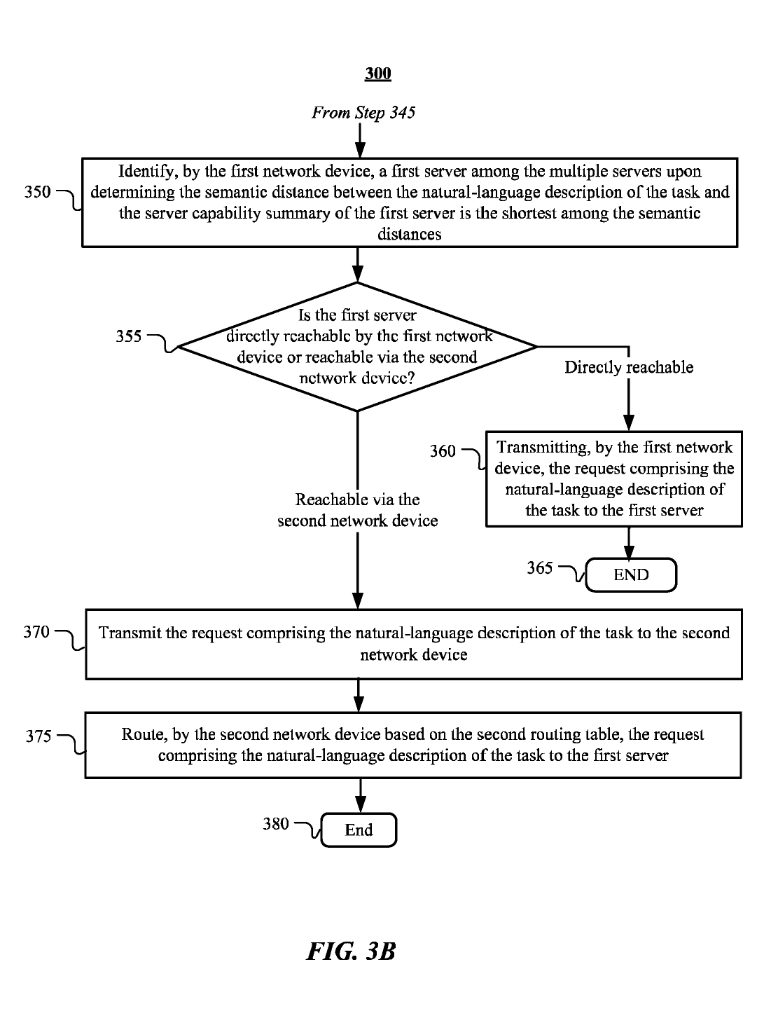

FIGS. 3A-3B illustrate a method 300 for natural language-based service discovery, in accordance with certain embodiments. Method 300 of FIGS. 3A-3B includes the following steps. Method 300 starts at step 305.

At step 310 of method 300, a second network device may receive multiple announcements from multiple servers. In certain embodiments, the second network device is a router. In certain embodiments, the second network device is a DNS server. Each of the announcements may include a natural-language description of capabilities of the corresponding server.

At step 315 of method 300, the second network device may generate a respective server capability summary in natural language based on the natural-language description of the capabilities associated with each server. For example, the respective server capability summary may be “I offer Infrastructure as a Service (IaaS) and Platform as a Service (PaaS).”

At step 320 of method 300, the second network device may build a second routing table based on the summarized capabilities in natural language. In certain embodiments, the second routing table includes APIs for servers that can be reached with each API associated with a respective capability described in natural language.

At step 325 of method 300, the second network device may transmit a single announcement that includes the server capability summaries in natural language to a first network device. In certain embodiments, the first network device is a router. In certain embodiments, the first network device is a DNS server.

At step 330 of method 300, the first network device may build a first routing table based on the single announcement received from the second network device via natural-language integration. The first routing table may specify server capability summaries associated with the multiple servers. Each server capability summary may be in natural language.

At step 335 of method 300, the first network device may receive a request including a natural-language description of a task from a client device. The task may be booking a particular flight.

At step 340 of method 300, the first network device may access the first routing table. For example, the first network device may access the records of APIs and their associated capabilities in the first routing table.

At step 345 of method 300, the first network device may determine, based on the first routing table, semantic distances between the natural-language description of the task and the server capability summaries. In certain embodiments, the first network device determines the semantic distances based on word embeddings, ontology-based methods, or graph-based methods using particular distance metrics such as cosine distance.

At step 350 of method 300, the first network device may identify a first server among the multiple servers upon determining the semantic distance between the natural-language description of the task and the server capability summary of the first server is the shortest among the semantic distances. The multiple servers have their respective server capability summaries. For example, the first server has a first server capability summary (e.g., I can order pizza), the second server has a second server capability summary (e.g., I can order sushi), and the third server has a third server capability summary (e.g., I offer IaaS). An example task is “I want to order pizza.” The semantic distance between “I can order pizza” and “I want to order pizza” would be the shortest among the semantic distances of all three servers with respect to the task. Accordingly, the first server would be identified.

At step 355 of method 300, the first network device may determine whether the first server is directly reachable by the first network device or reachable via the second network device. If the first server is directly reachable by the first network device, the first network device may transmit the request including the natural-language description of the task to the first server at step 360. Method 300 then ends at step 365.

If, at step 355, the first server is reachable via the second network device, the first network device may transmit the request that includes the natural-language description of the task to the second network device at step 370. At step 375, the second network device may route, based on the second routing table, the request including the natural-language description of the task to the first server. Method 300 then ends at step 380.

Although this disclosure describes and illustrates particular steps of method 300 of FIGS. 3A-3B as occurring in a particular order, this disclosure contemplates any suitable steps of method 300 of FIGS. 3A-3B occurring in any suitable order. Although this disclosure describes and illustrates an example method for natural language-based service discovery including the particular steps of method 300 of FIGS. 3A-3B, this disclosure contemplates any suitable method for natural language-based service discovery including any suitable steps, which may include all, some, or none of the steps of method 300 of FIGS. 3A-3B, where appropriate. Furthermore, although FIGS. 3A-3B describes and illustrates particular components, devices, or systems carrying out particular actions, this disclosure contemplates any suitable combination of any suitable components, devices, or systems carrying out any suitable actions.

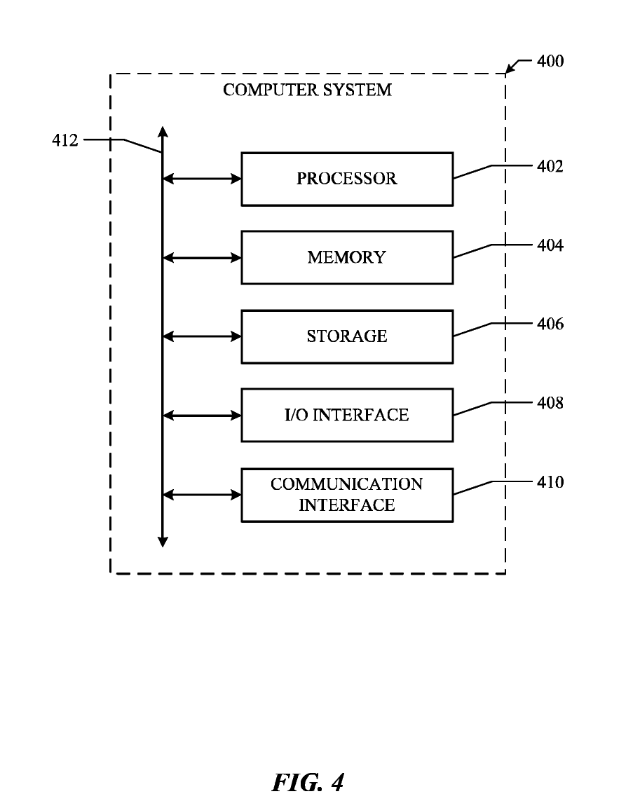

FIG. 4 illustrates a computer system 400, in accordance with certain embodiments. In particular embodiments, one or more computer system 400 perform one or more steps of one or more methods described or illustrated herein. In particular embodiments, one or more computer system 400 provide functionality described or illustrated herein. In particular embodiments, software running on one or more computer system 400 performs one or more steps of one or more methods described or illustrated herein or provides functionality described or illustrated herein. Particular embodiments include one or more portions of one or more computer system 400. Herein, reference to a computer system may encompass a computing device, and vice versa, where appropriate. Moreover, reference to a computer system may encompass one or more computer systems, where appropriate.

This disclosure contemplates any suitable number of computer system 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer system 400; be unitary or distributed; span multiple locations; span multiple machines; span multiple data centers; or reside in a cloud, which may include one or more cloud components in one or more networks. Where appropriate, one or more computer system 400 may perform without substantial spatial or temporal limitation one or more steps of one or more methods described or illustrated herein. As an example, and not by way of limitation, one or more computer system 400 may perform in real time or in batch mode one or more steps of one or more methods described or illustrated herein. One or more computer system 400 may perform at different times or at different locations one or more steps of one or more methods described or illustrated herein, where appropriate.

In particular embodiments, computer system 400 includes a processor 402, a memory 404, a storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer system 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein. Embodiments disclosed herein include a method, an apparatus, a storage medium, a system and a computer program product, wherein any feature mentioned in one category, e.g., a method, can be applied in another category, e.g., a system, as well.

What is claimed is:

1. A system, comprising:
one or more processors; and
one or more computer-readable non-transitory storage media comprising instructions that, when executed by the one or more processors, cause one or more components of system to perform operations comprising:
receiving, at a first network device and from a client device, a request comprising a natural-language description of a task;
accessing, by the first network device, a first routing table stored in the first network device, wherein the first routing table specifies a plurality of server capability summaries associated with a plurality of servers, respectively, wherein each of the plurality of server capability summaries is in natural language;
determining, by the first network device, a plurality of semantic distances between the natural-language description of the task and the plurality of server capability summaries, respectively;
identifying, by the first network device, a first server among the plurality of servers upon determining the semantic distance between the natural-language description of the task and the server capability summary of the first server is the shortest among the plurality of semantic distances; and
transmitting, by the first network device, the request comprising the natural-language description of the task to the first server.

2. The system of claim 1, the operations further comprising:
receiving, at the first network device and from the first server, an execution result of the task; and
transmitting, by the first network device, the execution result to the client device.

3. The system of claim 1, the operations further comprising:
receiving, at the first network device and from the plurality of servers, a plurality of announcements, wherein each of the plurality of announcements comprises a natural-language description of one or more server capabilities of a corresponding server;
executing, by the first network device, a generative artificial-intelligence (AI) model on the natural-language description of the one or more server capabilities associated with each server to generate a respective server capability summary in natural language;
building, by the first network device, the first routing table based on the server capability summary in natural language associated with each of the plurality of servers; and
storing the first routing table in the first network device.

4. The system of claim 1, the operations further comprising:
receiving, at the first network device and from one or more second network devices, one or more announcements, respectively, wherein each of the one or more announcements comprises an aggregation of one or more server capabilities associated with one or more servers of the plurality of servers, the one or more servers being reachable by a corresponding second network device, wherein the aggregation in each of the one or more announcements is in natural language; and
building, by the first network device, the first routing table based on the one or more announcements received from the one or more second network devices.

5. The system of claim 1, wherein transmitting the request comprising the natural-language description of the task to the first server comprises:
determining, by the first network device based on the first routing table, that the first server is reachable via a second network device; and
transmitting the request comprising the natural-language description of the task to the second network device, wherein the second network device is configured to route the request to the first server.

6. The system of claim 1, wherein the first routing table further specifies a plurality of application programming interfaces (APIs) associated with the plurality of servers, respectively, the operations further comprising:
identifying a first API associated with the first server, wherein transmitting the request comprising the natural-language description of the task to the first server is via the first API.

7. The system of claim 1, wherein the first network device comprises a router or a domain name system (DNS) server.

8. A method, comprising:
receiving, at a first network device and from a client device, a request comprising a natural-language description of a task;
accessing, by the first network device, a first routing table stored in the first network device, wherein the first routing table specifies a plurality of server capability summaries associated with a plurality of servers, respectively, wherein each of the plurality of server capability summaries is in natural language;
determining, by the first network device, a plurality of semantic distances between the natural-language description of the task and the plurality of server capability summaries, respectively;
identifying, by the first network device, a first server among the plurality of servers upon determining the semantic distance between the natural-language description of the task and the server capability summary of the first server is the shortest among the plurality of semantic distances; and
transmitting, by the first network device, the request comprising the natural-language description of the task to the first server.

9. The method of claim 8, further comprising:
receiving, at the first network device and from the first server, an execution result of the task; and
transmitting, by the first network device, the execution result to the client device.

10. The method of claim 8, further comprising:
receiving, at the first network device and from the plurality of servers, a plurality of announcements, wherein each of the plurality of announcements comprises a natural-language description of one or more server capabilities of a corresponding server;
executing, by the first network device, a generative artificial-intelligence (AI) model on the natural-language description of the one or more server capabilities associated with each server to generate a respective server capability summary in natural language;
building, by the first network device, the first routing table based on the server capability summary in natural language associated with each of the plurality of servers; and
storing the first routing table in the first network device.

11. The method of claim 8, further comprising:
receiving, at the first network device and from one or more second network devices, one or more announcements, respectively, wherein each of the one or more announcements comprises an aggregation of one or more server capabilities associated with one or more servers of the plurality of servers, the one or more servers being reachable by a corresponding second network device, wherein the aggregation in each of the one or more announcements is in natural language; and
building, by the first network device, the first routing table based on the one or more announcements received from the one or more second network devices.

12. The method of claim 8, wherein transmitting the request comprising the natural-language description of the task to the first server comprises:
determining, by the first network device based on the first routing table, that the first server is reachable via a second network device; and
transmitting the request comprising the natural-language description of the task to the second network device, wherein the second network device is configured to route the request to the first server.

13. The method of claim 8, wherein the first routing table further specifies a plurality of application programming interfaces (APIs) associated with the plurality of servers, respectively, the method further comprising:
identifying a first API associated with the first server, wherein transmitting the request comprising the natural-language description of the task to the first server is via the first API.

14. The method of claim 8, wherein the first network device comprises a router or a domain name system (DNS) server.

15. A non-transitory computer-readable medium comprising instructions that are configured, when executed by a processor, to:
receive, at a first network device and from a client device, a request comprising a natural-language description of a task;
access, by the first network device, a first routing table stored in the first network device, wherein the first routing table specifies a plurality of server capability summaries associated with a plurality of servers, respectively, wherein each of the plurality of server capability summaries is in natural language;
determine, by the first network device, a plurality of semantic distances between the natural-language description of the task and the plurality of server capability summaries, respectively;
identify, by the first network device, a first server among the plurality of servers upon determining the semantic distance between the natural-language description of the task and the server capability summary of the first server is the shortest among the plurality of semantic distances; and
transmit, by the first network device, the request comprising the natural-language description of the task to the first server.

16. The non-transitory computer-readable medium of claim 15, further comprising instructions that are configured, when executed by the processor, to:
receive, at the first network device and from the first server, an execution result of the task; and
transmit, by the first network device, the execution result to the client device.

17. The non-transitory computer-readable medium of claim 15, further comprising instructions that are configured, when executed by the processor, to:
receive, at the first network device and from the plurality of servers, a plurality of announcements, wherein each of the plurality of announcements comprises a natural-language description of one or more server capabilities of a corresponding server;
execute, by the first network device, a generative artificial-intelligence (AI) model on the natural-language description of the one or more server capabilities associated with each server to generate a respective server capability summary in natural language;
build, by the first network device, the first routing table based on the server capability summary in natural language associated with each of the plurality of servers; and
store the first routing table in the first network device.

18. The non-transitory computer-readable medium of claim 15, further comprising instructions that are configured, when executed by the processor, to:
receive, at the first network device and from one or more second network devices, one or more announcements, respectively, wherein each of the one or more announcements comprises an aggregation of one or more server capabilities associated with one or more servers of the plurality of servers, the one or more servers being reachable by a corresponding second network device, wherein the aggregation in each of the one or more announcements is in natural language; and
build, by the first network device, the first routing table based on the one or more announcements received from the one or more second network devices.

19. The non-transitory computer-readable medium of claim 15, wherein transmitting the request comprising the natural-language description of the task to the first server comprises:
determining, by the first network device based on the first routing table, that the first server is reachable via a second network device; and
transmitting the request comprising the natural-language description of the task to the second network device, wherein the second network device is configured to route the request to the first server.

20. The non-transitory computer-readable medium of claim 15, wherein the first routing table further specifies a plurality of application programming interfaces (APIs) associated with the plurality of servers, respectively, the non-transitory computer-readable medium further comprising instructions that are configured, when executed by the processor, to:
identify a first API associated with the first server, wherein transmitting the request comprising the natural-language description of the task to the first server is via the first API.
